(19) United States
(12) Patent Application Publication
(10) Pub. No.: US 2011/0125795 A1
(43) Pub. Date: May 26, 2011

(54) METHOD AND APPARATUS FOR SELECTING A MULTIMEDIA ITEM

(75) Inventor: Janto Skowronek, Eindhoven (NL)

(73) Assignee: KONINKLIJKE PHILIPS ELECTRONICS N.V., EINDHOVEN (NL)

(21) Appl. No.: 13/003,446

(22) PCT Filed: Jul. 10, 2009
(86) PCT No.: PCT/IB09/53010

§ 371 Date: Jan. 10, 2011

(30) Foreign Application Priority Data
Jul. 15, 2008 (EP) 08160377.1

(51) Int. Cl. G06F 17/30

(52) U.S. Cl. 707/780; 707/E17.014

(57) ABSTRACT

Multimedia items are selected from a plurality of candidate multimedia items by:

determining (201) a plurality of features characterizing a user collection of multimedia items; determining (203) a probability function from said determined features, said probability function having a plurality of maxima, said plurality of maxima indicating the probability that a user prefers an item having the combination of features represented by said maxima; and selecting (209) at least one multimedia item from a plurality of candidate multimedia items on the basis of at least one of said determined maxima.

### FIELD OF THE INVENTION

The present invention relates to a method and apparatus for selecting a multimedia item from a plurality of candidate multimedia items. In particular, but not exclusively, it relates to a music recommender system for selecting and recommending music for a playlist.

### BACKGROUND OF THE INVENTION

Music recommender systems exist that propose music by matching a description of music in a collection with a description of a user's preferences and can thus recommend music to the user that reflects the user's music taste. For example, a user might indicate preferences for up-tempo music and pop music and music matching one or both of these preferences might then be recommended to him.

A drawback of these existing recommender systems is that the provided recommendations normally include too much music that the user dislikes.

### SUMMARY OF THE INVENTION

The present invention seeks to minimize the provision of recommendations that are disliked by a user.

This is achieved according to an aspect of the present invention by a method of selecting a multimedia item from a plurality of candidate multimedia items, the method comprising the steps of: determining a plurality of features characterizing a user collection of multimedia items; determining a probability function from the determined features, the probability function having a plurality of maxima, the plurality of maxima indicating the probability that a user prefers an item having the combination of features represented by the maxima; and selecting at least one multimedia item from a plurality of candidate multimedia items on the basis of at least one of the determined maxima.

This is also achieved according to a second aspect of the present invention by an apparatus for selecting a multimedia item from a plurality of candidate multimedia items, the apparatus comprising: storage means for storing a plurality of candidate multimedia items; processing means for determining a plurality of features characterizing a user collection of multimedia items and determining a probability function from the determined features, the probability function having a plurality of maxima, the plurality of maxima indicating the probability that a user prefers an item having the combination of features represented by the maxima; and means for selecting at least one multimedia item from the plurality of candidate multimedia items on the basis of at least one of the determined maxima. The apparatus may be a consumer device or a professional device, e.g. a portable MP3 player or a professional device used by music providers.

This is also achieved according to yet another aspect of the present invention by a system for recommending a multimedia item, the system comprising: apparatus according to the second aspect above; a user terminal for playing multimedia items, the user terminal including user storage means for storing the user collection of multimedia items; an interface for communicating with the apparatus and the user terminal such that items selected by the apparatus are recommended to the user.

The parametric music description or feature profile of the music can be manually annotated metadata or algorithmically computed audio features or can comprise a combination of both. One way to interpret such a feature profile is a probability function that describes which areas in the (N-dimensional) feature space most likely represent music the user likes. That means, if much of the music of the user's collection falls into a particular region in the feature space, then the probability that the user likes this music is high. Then the assumption of the recommender system is that the user will likely appreciate new music that falls into that feature space region as well.

The personalized exploration of new music is achieved in which features, i.e. a parametric representation, of a user's collection are used in the form of a probability function that determines how likely it is that the user will appreciate music that lies in a certain region of the user feature space. By determining what kind of music a user has in his collection instead of determining what music a user purchases or plays back and by determining the combinations of features of the music that a user has in his collection (e.g. 90s pop music, but not 90s rock music or 80s pop music) instead of determining the single features (e.g. ‘music from the 90s’, ‘pop music’), recommendations for new music are less likely to be disliked.

Features can be automatically extracted from music, using known automatic music extraction algorithms. An extracted feature is not necessarily meaningful to a user (e.g. in the case of extracted MFCC coefficients).

The at least one of the determined maxima may not be the absolute maximum of the determined probability function. Secondary maxima of the probability function are thus used to construct queries for a search. In this way, queries are generated that represent neither the type of music the user already has a lot of (the absolute maximum of the probability function) nor the music that the user would not like (low values of the probability function).

The at least one of the determined maxima may be within a predetermined range of the absolute maximum of the determined probability function, so that the selection made is similar to the user's current choices.

The step of selecting at least one multimedia item may comprise the steps of: determining at least one feature vector corresponding to the at least one of the determined maxima; and selecting at least one multimedia item having a feature vector similar to the determined at least one feature vector, so that multiple features can be taken into consideration.

Given the existing algorithms and their robustness, the probability function may be modeled by multiple Gaussian functions.

To avoid duplication, the plurality of candidate multimedia items exclude multimedia items of the user collection of multimedia items. This may be achieved by maintaining a log of previously selected multimedia items; and wherein the step of selecting at least one multimedia item comprises the step of: selecting at least one multimedia item from the plurality of candidate multimedia items which are not included in the log.

The selection may be repeated by selecting at least one multimedia item from the plurality of candidate multimedia items on the basis of at least one other of the determined maxima.

The step of selecting at least one multimedia item may comprise: selecting a plurality of multimedia items from said user collection of multimedia items on the basis of at least one of said determined maxima; allowing the user to select at least one of said plurality of selected multimedia items; and generating a query to select at least one multimedia item from said plurality of candidate multimedia items on the basis of said user-selected at least one of said plurality of selected multimedia items.

### BRIEF DESCRIPTION OF DRAWINGS

For a more complete understanding of the present invention, reference is now made to the following description taken in conjunction with the accompanying drawing, in which:

FIG. 1 is a simplified schematic diagram of a recommender system according to an embodiment of the present invention; and

FIG. 2 is a flowchart of the method according to an embodiment of the present invention.

### DETAILED DESCRIPTION OF EMBODIMENTS OF THE INVENTION

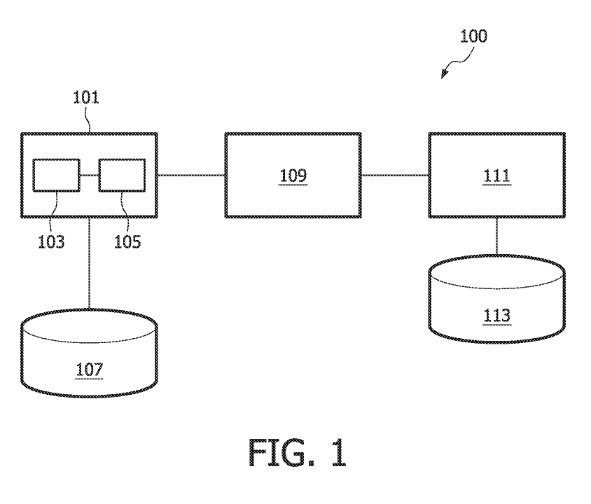

With reference to FIG. 1, the recommender system of an embodiment of the present invention will be described in detail. The recommender system 100 comprises a recommender 101. The recommender 101 comprises a processor 103 and a selector 105. The recommender 101 is connected to definitive storage means 107 which stores a plurality of candidate multimedia items, such as music, audio/visual items, digital images (photographs) or the like, that is, a definitive collection of multimedia items to which the user has access.

The recommender 101 is connected to an interface 109 such as a computer terminal. The interface communicates with a user terminal 111 which may be a MP3 player, mobile telephone, PDA or the like. The interface 109 may communicate wirelessly with the user device 111 or via a wired connection. The user terminal 111 is connected to a user storage means 113 which may be integral with the user terminal 111 or remotely connected. The user storage means 113 stores the user's collection of multimedia items. Alternatively, the user collection of multimedia items may be stored and/or played on the interface 109, i.e. the user terminal 111 and the interface 109 are integral devices.

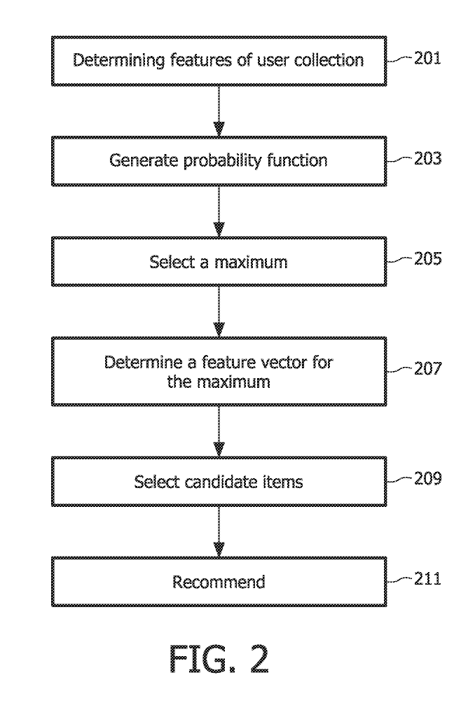

Operation of the system will now be described with reference to FIG. 2.

In step 201, the recommender 101 determines the features of the user collection of multimedia items which are currently stored in the user storage means 113 via the user terminal 111 and the interface 109. The determined features are a description reflecting the user's music taste. This may comprise manually annotated metadata or algorithmically computed audio features or a combination of these. The processor 103 of the recommender 101 determines a probability function from the determined features, step 203. The probability function has a plurality of maxima, for example a multiple Gaussian function. Therefore, multiple local maxima can be identified. Although any probability density function having multiple maxima can be utilized, Gaussian functions are well known and there are many existing algorithms and methods which provide a robust estimation of probability functions from training data. In the embodiment, the probability function is derived using a Gaussian mixture model in which the desired probability function is approximated by the weighted sum of a number of Gaussian distributions. The parameters that describe this Gaussian distribution are estimated from a number of observations, i.e. the feature vectors of the user's collection of multimedia items, by using a known technique such as that described by Figueiredo, M., Leito J., Jain, A. K., “On fitting mixture models”, in Energy Minimization Methods in Computer Vision and Pattern Recognition (E. Hancock and M. Pellilo, eds) pp 54-69, Springer Verlag, 1999.

A search algorithm is then determined to select at least one of the local maxima, step 205. In order to widen the user's choice of recommended items, the local maxima selected are those which are not close to the absolute maximum. The maxima may be selected by simply choosing a local maximum with the lowest value in the probability function or using a random process to choose one of these maxima. Alternatively, a threshold can be used to limit the distance from the absolute maximum of the probability function (the “core” of the user's music taste), so that items which are selected are not too far away for the user's preferred choice. The higher the distance threshold, the more distant the item will be from the “core” of the user's collection and the more explorative the recommender 101 behaves. This threshold may be set by the user as an exploration factor. To prevent the selection from being too close to the “core” of the user's collection, the threshold may be combined with a second lower distance threshold such that the local maximum should not be too close to the absolute maximum.

Alternatively, thresholds can be used for the value of the probability function: the probability value of the chosen local maximum should be above a predetermined threshold so as to prevent the chosen local maximum having too low a probability value which the user may not appreciate. This may be extended to consider a second threshold: the chosen maximum should be beneath the threshold to prevent selection of items too similar to that which the user already has.

The search algorithm is constructed, step 207, from the location of the at least one chosen maximum in the feature space. The values of the features at the location(s) are used to form the query. The values may be compiled into a single feature vector.

The formed query is then used on the multimedia items stored on the definitive storage means 107 to find those candidate multimedia items that meet the search query, step 209. This may be achieved using efficient data mining techniques to find the best matches in the store of items consisting of corresponding values.

These items are returned and recommended by the recommender 101 to the user, step 211.

In a further embodiment, the system 100 may further include a logging engine, not shown here, which maintains a record of the multimedia items that have already been proposed to the user in order to avoid duplication. The logging engine can also be used to change the maxima chosen and hence change the query in the event that the determined features of the user's collection have not changed since the last query was generated and/or propose items from a candidate list (x top similar items) that was not proposed when using the same query the last time.

In yet a further embodiment, the system may also provide the user with more transparency and intervention possibilities. A first query may be generated that searches the user's collection in the user storage means 113 for items closest to the selected maxima and then allow the user to select which of these items should serve as a basis for the next query.

The interface may communicate with the definitive collection stored on the definitive storage means 107 via the internet. The recommender 101 may be integral with the interface 109 or part of a remote server system. The recommender 101 of the above embodiments may be used in music online stores or internet radio services.

Although embodiments of the present invention have been illustrated in the accompanying drawings and described in the foregoing description, it will be understood that the invention is not limited to the embodiments disclosed but is capable of numerous modifications without departing from the scope of the invention as set out in the following claims.

‘Means’, as will be apparent to a person skilled in the art, are meant to include any hardware (such as separate or integrated circuits or electronic elements) or software (such as programs or parts of programs) which, in operation, reproduce or are designed to reproduce a specified function, be it solely or in conjunction with other functions, be it in isolation or in co-operation with other elements. The invention can be implemented by means of hardware comprising several distinct elements, and by means of a suitably programmed computer. In the apparatus claim enumerating several means, several of these means can be embodied by one and the same item of hardware. ‘Computer program product’ is to be understood to mean any software product stored on a computer-readable medium, such as a floppy disk, downloadable via a network, such as the Internet, or marketable in any other manner.

1. A method of selecting a multimedia item from a plurality of candidate multimedia items, the method comprising the steps of:
determining (201) a plurality of features characterizing a user collection of multimedia items;
determining (203) a probability function from said determined features, said probability function having a plurality of maxima, said plurality of maxima indicating the probability that a user prefers an item having the combination of features represented by said maxima; and
selecting (209) at least one multimedia item from a plurality of candidate multimedia items on the basis of at least one of said determined maxima.

2. A method according to claim 1, wherein said at least one of said determined maxima is not the absolute maximum of said determined probability function.

3. A method according to claim 2, wherein said at least one of said determined maxima is within a predetermined range of said absolute maximum of said determined probability function.

4. A method according to claim 1, wherein the step of selecting at least one multimedia item comprises the steps of:
determining at least one feature vector corresponding to said at least one of said determined maxima; and
selecting at least one multimedia item having a feature vector similar to said determined at least one feature vector.

5. A method according to claim 1, wherein said probability function is modeled by multiple Gaussian functions.

6. A method according to claim 1, wherein the said plurality of candidate multimedia items exclude multimedia items of said user collection of multimedia items.

7. A method according to claim 1, wherein the method further comprises the step of:
maintaining a log of previously selected multimedia items;
and wherein the step of selecting at least one multimedia item comprises the step of:
selecting at least one multimedia item from said plurality of candidate multimedia items which are not included in said log.

8. A method according to claim 1, wherein the method further comprises the steps of:
selecting at least one multimedia item from said plurality of candidate multimedia items on the basis of at least one other of said determined maxima.

9. A method according to claim 1, wherein the step of selecting at least one multimedia item comprises:
selecting a plurality of multimedia items from said user collection of multimedia items on the basis of at least one of said determined maxima;
allowing the user to select at least one of said plurality of selected multimedia items; and
generating a query to select at least one multimedia item from said plurality of candidate multimedia items on the basis of said user-selected at least one of said plurality of selected multimedia items.

10. A computer program product comprising a plurality of program code portions for carrying out the method according to claim 1.

11. Apparatus (101) for selecting a multimedia item from a plurality of candidate multimedia items, said apparatus (101) comprising:
a store (107) for storing a plurality of candidate multimedia items;
a processor (103) for determining a plurality of features characterizing a user collection of multimedia items and determining a probability function from said determined features, said probability function having a plurality of maxima, said plurality of maxima indicating the probability that a user prefers an item having the combination of features represented by said maxima; and
a selector for selecting (105) at least one multimedia item from said plurality of candidate multimedia items on the basis of at least one of said determined maxima.

12. A recommender system (100) for recommending a multimedia item, the system comprising:
apparatus (101) according to claim 12;
a user terminal (111) for playing multimedia items, said user terminal including user storage means (113) for storing said user collection of multimedia items;
an interface (109) for communicating with said apparatus (101) and said user terminal (111) such that items selected by the apparatus (101) are recommended to the user.
